(19) United States
(12) Patent Application Publication
(10) Pub. No.: US 2024/0146038 A1
(43) Pub. Date: May 2, 2024

(54) Low Voltage; Medium Voltage; or High Voltage Cable Fixation System

(71) Applicant: ABB Schweiz AG, Baden (CH)

(72) Inventors: Jan Vyhlidal, Strelice (CZ); Radovan Renda, Brno (CZ)

(73) Assignee: ABB Schweiz AG, Baden (CH)

(21) Appl. No.: 18/495,860

(22) Filed: Oct. 27, 2023

(30) Foreign Application Priority Data
Oct. 28, 2022 (EP) 22204448.9

(51) Int. Cl. H02B 1/30; H02G 3/32

(52) U.S. Cl. CPC H02B 1/305; H02G 3/32; H02B 13/035

(57) ABSTRACT

A cable fixation system includes a cable strip and a cable rack. The cable rack is configured to be mounted to a cable compartment of a low voltage, medium voltage, or high voltage switchgear. The cable rack comprises at least one hole. A first end of the cable strip is configured to connect to a second end of the cable strip. The cable strip is configured to fix or clamp a cable of the low voltage, medium voltage, or high voltage switchgear, and wherein to fix or clamp the cable: the cable strip passes through one or more holes of the at least one hole of the cable rack, the cable strip loops round at least a part of the cable, and the first end of the cable strip is connected to the second end of the cable strip.

### CROSS-REFERENCE TO RELATED APPLICATIONS

The instant application claims priority to European Patent Application No. 22204448.9, filed Oct. 28, 2022 which is incorporated herein in its entirety by reference.

### FIELD OF THE DISCLOSURE

The present disclosure generally relates to a low voltage, medium voltage or high voltage fixation system for a low voltage, medium voltage or high voltage switchgear.

### BACKGROUND OF THE INVENTION

Incoming and outgoing cables to low, medium, and high voltage switchgear with rated currents exceeding 100 A are required to be fixed in position.

Currently cable clamps as shown in FIG. 1 are utilized, providing mechanical fixation of the low voltage, medium voltage or high voltage cable to the frame of the switchgear.

These clamps are usually arranged in a set fixed in the cable compartment of the low voltage, medium voltage or high voltage switchgear, see FIG. 2 that shows the fixation of cable clamps in a cable compartment of a medium voltage switchgear. Such clamps are usually arranged in a 3-phase configuration with at least one cable and cable connection/clamp per phase. The same cable clamp arrangement is also used in the case of the use of a single 3-phase cable, but in this case, a bigger cable clamp is needed to accommodate a bigger diameter of the 3-phase cable.

FIG. 3 shows assembly of the cables in the cable compartment of a medium voltage switchgear using the known cable clamps.

However, the present cable clamp consists of several small parts that need to be assembled, the assembly of the cable clamp requires specific tools, the assembly takes time and costs money and requires significant amounts of raw material, and the cable clamp is expensive.

### BRIEF SUMMARY OF THE INVENTION

Therefore, it would be advantageous to have an improved technique to fix or clamp cables in a compartment of a low voltage, medium voltage or high voltage switchgear, such as an air or gas insulated switchgear. It is to be noted that the fixation system is described with respect to a medium voltage air or gas insulated switchgear, but finds utility also for low voltage and high voltage switchgear.

In an aspect, there is provided a low voltage, medium voltage or high voltage cable fixation system, comprising:
a cable strip; and
a cable rack.

The cable rack is configured to be mounted to a cable compartment of a low voltage, medium voltage, or high voltage switchgear. The cable rack comprises at least one hole. A first end of the cable strip is configured to connect to a second end of the cable strip. The cable strip is configured to fix or clamp a cable of the low voltage, medium voltage, or high voltage switchgear. To fix or clamp the cable the following applies: the cable strip passes through one or more holes of the at least one hole of the cable rack, the cable strip loops round at least a part of the cable, and the first end of the cable strip is connected to the second end of the cable strip.

### BRIEF DESCRIPTION OF THE SEVERAL VIEWS OF THE DRAWING(S)

FIG. 1 shows a standard known cable clamp.

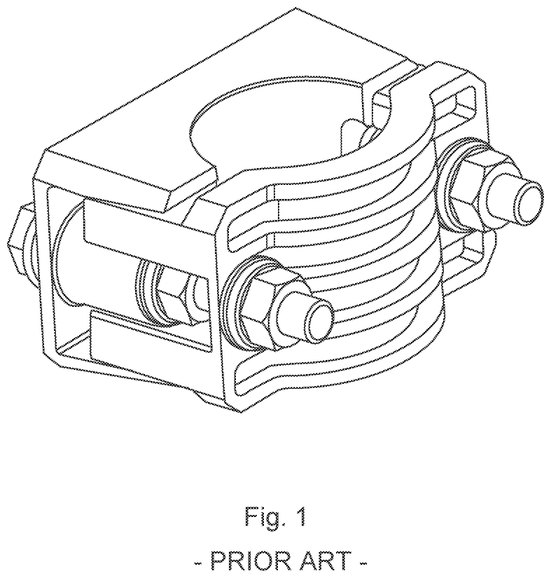

FIG. 2 shows standard known cable clamps arranged for the fixation of cables of a medium voltage switchgear.

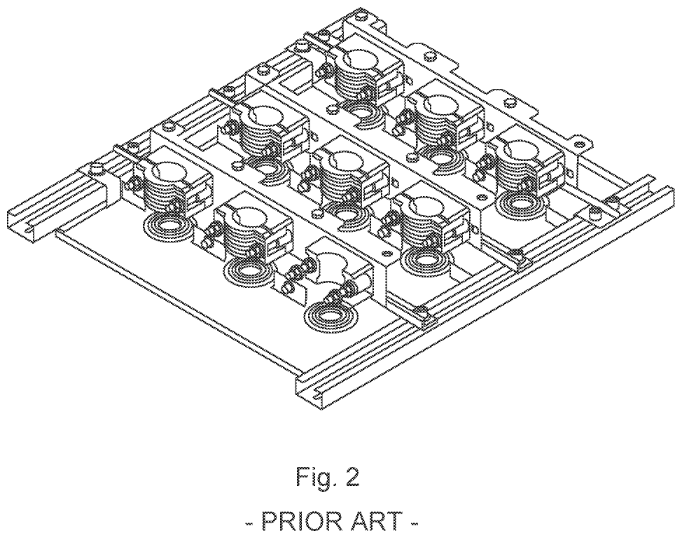

FIG. 3 shows standard known cable clamps fixing cables of a medium voltage switchgear.

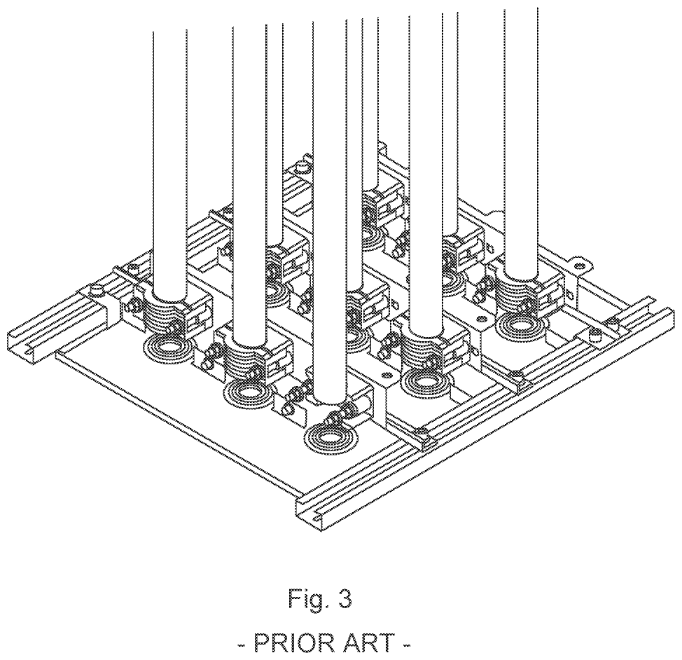

FIGS. 4A, 4B and 4C show examples of cable strips of the new cable fixation system in accordance with the disclosure.

FIGS. 5A and 5B show different perspectives of an exemplary embodiment of the new fixation system within a cable compartment of a medium voltage switchgear.

FIG. 6 shows an example of the new fixation system in accordance with the disclosure.

FIG. 7 shows an example of a cable rack of the new fixation system.

FIGS. 8A and 8B show three new fixation systems placed adjacent one another, where each is fixing or clamping three cables of phases of a 3-phase system.

### DETAILED DESCRIPTION OF THE INVENTION

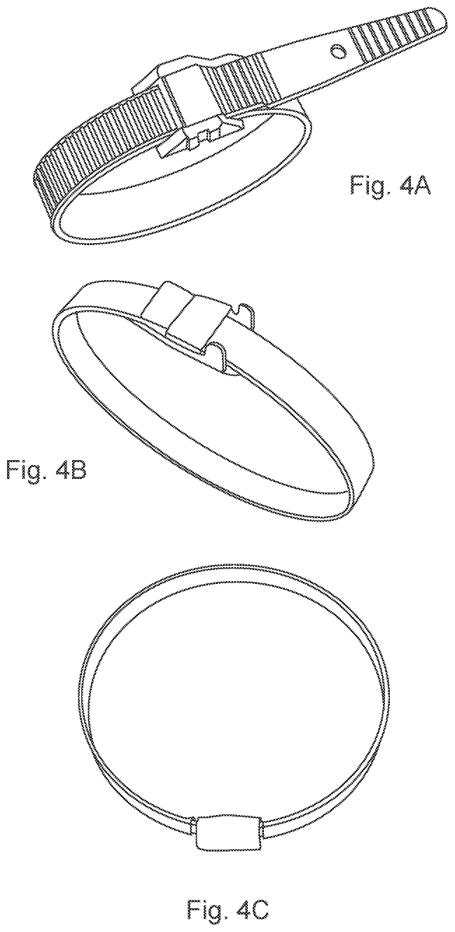

The new fixation system, in different embodiments, is now described in detail where reference is made to FIGS. 4A-8B.

An example of a low voltage, medium voltage or high voltage cable fixation system comprises a cable strip, and a cable rack. The cable rack is configured to be mounted to a cable compartment of a low voltage, medium voltage, or high voltage switchgear. The cable rack comprises at least one hole. A first end of the cable strip is configured to connect to a second end of the cable strip. The cable strip is configured to fix or clamp a cable of the low voltage, medium voltage, or high voltage switchgear. To fix or clamp the cable the following applies:
the cable strip passes through one or more holes of the at least one hole of the cable rack,
the cable strip loops round at least a part of the cable, and
the first end of the cable strip is connected to the second end of the cable strip.

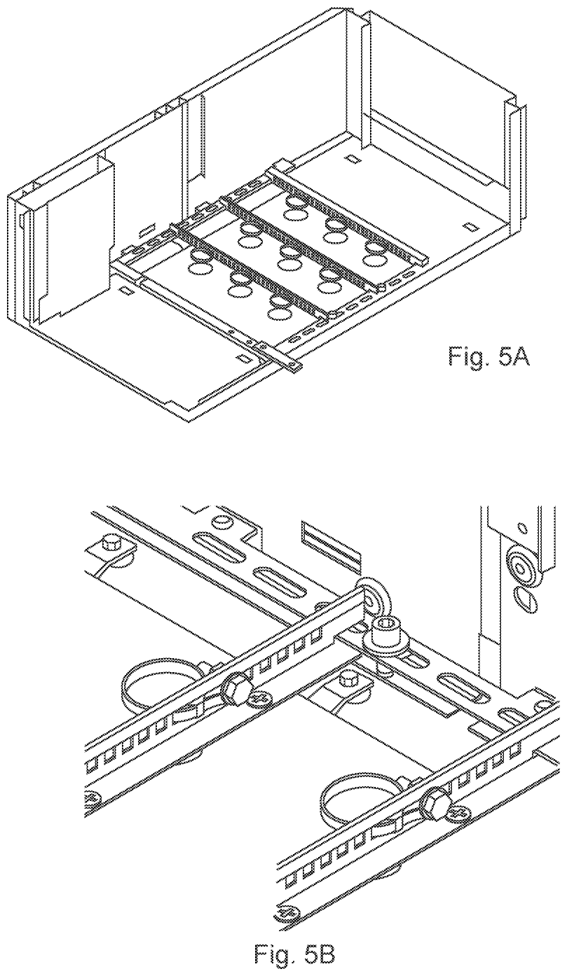

As shown for example in FIGS. 5A and 5B, the cable rack can be mounted for example to the base of the compartment of the switchgear. The can be mounting brackets, or mounting holes, provided on the cable rack in order to secure the cable rack to compartment.

As shown for example in FIGS. 5A, 5B, 6, 8A and 8B, the cable rack can have a number of holes along its length, but it could just by one hole, and this hole or holes, utilized when connecting cable strip to the cable rack.

Examples of cable strips are shown in FIGS. 4A and 4B, the cable strips as shown in FIGS. 5A, 5B, 6, 8A and 8B. As shown in FIG. 4A, the two ends of the cable strip have connection means enabling the two ends of the cable strip to be connected to each other. For example, a first end of the cable strip can slide through a second end of the cable strip and ridges on the first end of the cable strip click past the ratchet like system at the second end to enable the first end to be pulled through the second end but not pulled back. However, the second end can have a clasp like system that clamps down on the first end of the cable strip. Other connection means possible.

Thus, the cable strip compulsory one hole of the cable rack, around a cable that is to be fixed or clamped and two ends of the cable strip can be connected to each other, and the first end of the cable strip can for example by pulled tight through the second end of the cable strip to tighten the cable strip around the cable. However, to provide for fixing or clamping of the cable via a cable strip that is oriented parallel to the cable rack, and provide more security from the cable moving laterally, the cable strip can go through one hole of the cable rack, around the cable, back through a second hole laterally spaced from the first hole, and then the two ends of the cable strip can be connected to the other.

In this manner, new cable fixing or clamping mechanism is provided via the new cable fixation system in the form of cable rack at cable strip, that facilitates clamping the cable easily and efficiently, and secures the cable from moving even when short-circuit currents of an example 100A and greater pass through the cable.

In an example, the cable rack comprises a plurality of holes, and wherein to fix or clamp the cable: the cable strip passes through two holes of the plurality of holes of the cable rack.

In an example, the cable strip has a mechanical strength of 1 kN or greater than 1 kN.

In an example, the cable strip comprises thermoset, thermoplastic, or a rubber material.

In an example, the cable strip comprises a metallic material.

In an example, the cable strip comprises a plurality of layers, and wherein at least two of the layers comprise different materials.

In an example, the cable strip comprises a layer of one material with particles of a second material.

In an example, the cable strip is UV resistant and/or is flame retardant.

In an example, the fixation system comprises a common rail. The common rail is configured to be directly connected to a cable compartment, and the cable rack and common rail are configured such that the cable rack can be connected to the common rail to mount the cable rack to the cable compartment.

In an example, the fixation system comprises a second common rail. The second common rail is configured to be directly connected to a cable compartment, and the cable rack and second common rail are configured such that the cable rack can be connected at one end to the first common rail and connected at the opposite end to the second common rail to mount the cable rack to the cable compartment.

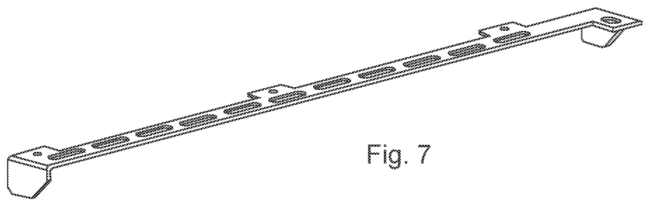

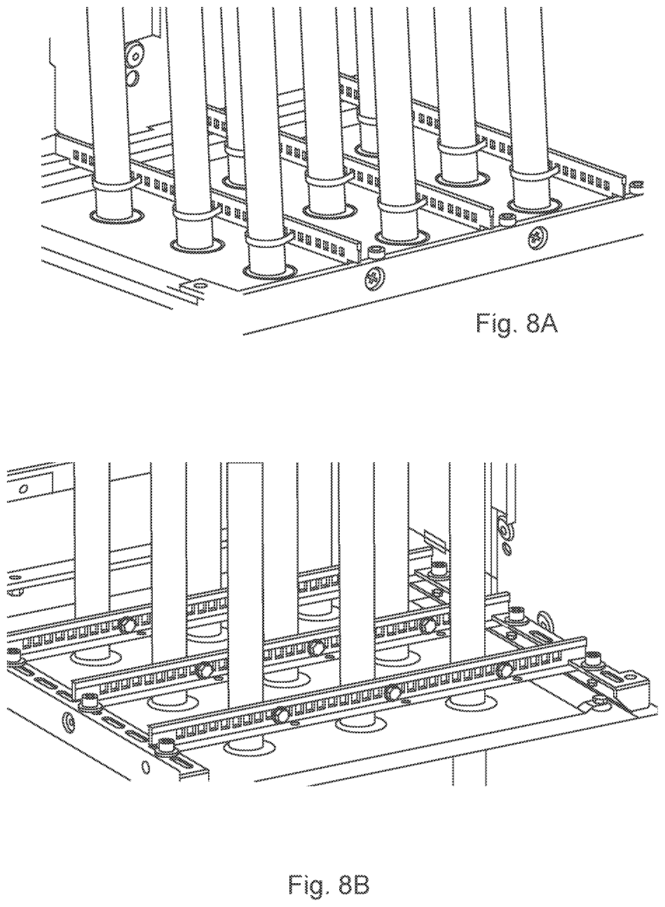

Such a common rail in shown in FIG. 7, with cable racks shown connected to common rails in FIGS. 5A, 5B, 8A and 8B, where the common rails are connected to the base of the cable compartment.

An example of a low voltage, medium voltage or high voltage cable fixation system comprises a cable strip, and a cable rack. The cable rack is configured to be mounted to a cable compartment of a low voltage, medium voltage, or high voltage switchgear. The cable rack comprises a plurality of holes. A first end of the cable strip is configured to connect to the cable rack via a hole of the plurality of holes of the cable rack. A second end of the cable strip is configured to connect to the cable rack via a hole of the plurality of holes of the cable rack. The cable strip is configured to fix or clamp a cable of the low voltage, medium voltage, or high voltage switchgear. To fix or clamp the cable the following applies:
the first end of the cable strip is connected to the cable rack via a first hole of the plurality of holes of the cable rack,
the second end of the cable strip is connected to the cable rack via a second hole of the plurality of holes of the cable rack, and
the cable strip loops round at least a part of the cable.

In an example, the first end of the cable strip is connected to the cable rack via a bolt or screw through the first hole of the plurality of holes of the cable rack. The second end of the cable strip is connected to the cable rack via a bolt or screw through the second hole of the plurality of holes of the cable rack.

Thus, the cable rack is equivalent to that described for the first example above, except that it has a plurality of holes via which the cable strips connected to the cable rack to fix or clamp the cable. However, in this example one end of the cable strip is bolted or screwed to the cable rack at one location via a first hole, and the other end of the cable strip is bolted or screwed to the cable rack location via signal, and the cable strip loops around the cable and fixes or clamps it.

In an example, the first end of the cable strip is connected to the cable rack via a bolt or screw through the first hole of the plurality of holes of the cable rack and wherein the second end of the cable strip is connected to the cable rack via the bolt or screw through the first hole of the plurality of holes of the cable rack.

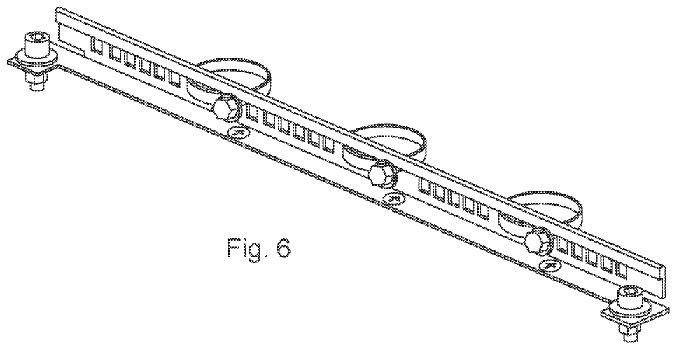

Thus, cable strip loops from the cable and one end passes through one hole in the cable rack, along the back of the cable rack opposite to the cable is located, to location of the second hole in the cable rack. At this location a bolt or screw can fix this end of the cable strip to the cable rack and also fix the other end of the cable strip to the cable rack. This is shown for example in FIG. 6

In an example, the first hole of the plurality of holes of the cable rack is threaded.

In an example, the second hole of the plurality of holes of the cable rack is threaded.

In an example, the first end of the cable strip is connected to the cable rack via the bolt through the first hole of the plurality of holes of the cable rack from one side and a nut from the other side, and wherein the second end of the cable strip is connected to the cable rack via the bolt or screw through the second hole of the plurality of holes of the cable rack from one side and a nut from the other side.

The use of nut and bolt securement provides for secure fixing of the ends of the cable strip to the cable rack.

In an example, the first end of the cable strip is connected to the cable rack via the bolt through the first hole of the plurality of holes of the cable rack from one side and a nut from the other side and wherein the second end of the cable strip is connected to the cable rack via the bolt or screw through the first hole of the plurality of holes of the cable rack from one side and the nut from the other side.

The use of nut and bolt securement provides for secure fixing of the ends of the cable strip to the cable rack is a location. The nut and bolt securement of the cable strip to the cable rack, with the cable strip able to loop around the cable, is shown for example in FIG. 5.

In an example, the cable strip has a mechanical strength of 1 kN or greater than 1 kN.

In an example, the cable strip comprises thermoset, thermoplastic, or a rubber material.

In an example, the cable strip comprises a metallic material.

In an example, the cable strip comprises a plurality of layers, and wherein at least two of the layers comprise different materials.

In an example, the cable strip comprises a layer of one material with particles of a second material.

In an example, the cable strip is UV resistant and/or is flame retardant.

In an example, the fixation system comprises a common rail. The common rail is configured to be directly connected to a cable compartment, and the cable rack and common rail are configured such that the cable rack can be connected to the common rail to mount the cable rack to the cable compartment.

In an example, the fixation system comprises a second common rail. The second common rail is configured to be directly connected to a cable compartment, and the cable rack and second common rail are configured such that the cable rack can be connected at one end to the first common rail and connected at the opposite end to the second common rail to mount the cable rack to the cable compartment.

The cable fixation system is now described in further specific detail, where reference is again made to FIGS. 4A8B.

The new cable strips of the new fixation system are shown in FIGS. 4A and 4B. These are suitable for cable fixation in low/medium/high voltage switchgear to fix cables with high current capacity (exceeding 100 A short-circuit current and resulting mechanical forces) due to their mechanical strength and materials used.

Such cable strips are easy to fix in the cable compartment of the switchgear, and examples that connect one end to the other can be fixed to the cable rack without any tools and are extremely fast to assemble. In case someone needs to release the strip, a tool can be used. Some of the cable strips are also fixed to the cable rack involving the use of for example a nut and bolt connection, and appropriate simple tooling is then required.

Features of the cable strips are:
Sufficient mechanical strength (>1 kN)
Material should be at least partly:
   UV resistant
   Flame retardant
   Should not damage cable insulation (but can have additional parts to avoid sharp edges being exposed to the cable insulation)
   Can be made out of thermoset, thermoplast or rubber material
   Can be made also out of at least partly metallic material with or without additional layers or particles of another material
   Strip can form at least partially the loop around the cable and may consist of one or more parts
   The strip can be used with two locking mechanisms (one on each side)

Sufficient mechanical strength for the cable strip is required in order to survive the mechanical forces coming from cable installation and its weight as well as additional mechanical forces during short-circuit current situations, such as during testing.

The cable strips work alongside cable racks that are lead to a modification of the switchgear cable compartment, to enable to fix cable racks to the base of the switchgear for example, to which cable strips can be fixed, as shown in FIG. 5A.

As shown in FIGS. 5A and 5B, at least one cable rack (in the case of single cable connected per phase) is used, but there could be three cable racks utilized. A cable rack with three cable strips is shown in FIG. 6, that provides for modular assembly.

As shown in FIG. 6 the cable rack has perforations or holes that enables the cables strips to be used to fix or clamp cables. An advantage of the cable rack design lies in several possibilities to place the cable strip, due to multiple perforations that enables higher flexibility in location of required fixation.

There can be only one cable strip used (single stripe for 3-phase cable) or three stripes (for the case with 3 single-phase cables). The cable rack has sufficient mechanical strength and should also avoid mechanical damage to the cable strips (thus decreasing mechanical strength of the stripe), for example by not having sharp edges.

The cable rack can be made from an electrically conductive material or an insulated material in the situation where the earthing is done by other means.

Furthermore, in order to provide even higher level of flexibility in placement of the cable within a cable compartment, the cable rack can be in the form of a in effect a common rail, see FIG. 7, to which the cable rack or racks are to be fixed.

This common rail also has some perforations, that enables flexibility in placement of the cable rack or racks within cable compartment of the switchgear.

An example of the full assembly of the cable racks to the common rail is shown in FIGS. 5A, 5B, 8A and 8B.

In an example, the cable rack comprises a plurality of holes, and to fix or clamp the cable, the cable strip passes through two holes of the plurality of holes of the cable rack.

In an example, the cable strip has a mechanical strength of 1 kN or greater than 1 kN.

In an example, the cable strip comprises thermoset, thermoplastic, or a rubber material.

In an example, the cable strip comprises a metallic material.

In an example, the cable strip comprises a plurality of layers, and at least two of the layers comprise different materials.

In an example, the cable strip comprises a layer of one material with particles of a second material.

In an example, the cable strip is UV resistant and/or is flame retardant.

In an aspect, there is provided a low voltage, medium voltage or high voltage cable fixation system, comprising:
a cable strip; and
a cable rack.

The cable rack is configured to be mounted to a cable compartment of a low voltage, medium voltage, or high voltage switchgear. The cable rack comprises a plurality of holes. A first end of the cable strip is configured to connect to the cable rack via a hole of the plurality of holes of the cable rack. A second end of the cable strip is configured to connect to the cable rack via a hole of the plurality of holes of the cable rack. The cable strip is configured to fix or clamp a cable of the low voltage, medium voltage, or high voltage switchgear. To fix or clamp the cable the following applies:
the first end of the cable strip is connected to the cable rack via a first hole of the plurality of holes of the cable rack,
the second end of the cable strip is connected to the cable rack via a second hole of the plurality of holes of the cable rack, and
the cable strip loops round at least a part of the cable.

In an example, the first end of the cable strip is connected to the cable rack via a bolt or screw through the first hole of the plurality of holes of the cable rack, and the second end of the cable strip is connected to the cable rack via a bolt or screw through the second hole of the plurality of holes of the cable rack.

In an example, the first end of the cable strip is connected to the cable rack via a bolt or screw through the first hole of the plurality of holes of the cable rack and wherein the second end of the cable strip is connected to the cable rack via the bolt or screw through the first hole of the plurality of holes of the cable rack.

In an example, the first hole of the plurality of holes of the cable rack is threaded, and the second hole of the plurality of holes of the cable rack is threaded.

In an example, the first end of the cable strip is connected to the cable rack via the bolt through the first hole of the plurality of holes of the cable rack from one side and a nut from the other side. The second end of the cable strip is connected to the cable rack via the bolt or screw through the second hole of the plurality of holes of the cable rack from one side and a nut from the other side.

In an example, the first end of the cable strip is connected to the cable rack via the bolt through the first hole of the plurality of holes of the cable rack from one side and a nut from the other side. The second end of the cable strip is connected to the cable rack via the bolt or screw through the first hole of the plurality of holes of the cable rack from one side and the nut from the other side.

In an example, the cable strip has a mechanical strength of 1 kN or greater than 1 kN.

In an example, the cable strip comprises thermoset, thermoplastic, or a rubber material.

In an example, the cable strip comprises a metallic material.

The above aspects and examples will become apparent from and be elucidated with reference to the embodiments described hereinafter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A low voltage, medium voltage or high voltage cable fixation system, comprising:
a cable strip; and
a cable rack;
wherein the cable rack is configured to be mounted to a cable compartment of a low voltage, medium voltage, or high voltage switchgear;
wherein the cable rack comprises at least one hole;
wherein a first end of the cable strip is configured to connect to a second end of the cable strip;
wherein the cable strip is configured to fix or clamp a cable of the low voltage, medium voltage, or high voltage switchgear; and
wherein to fix or clamp the cable: the cable strip passes through one or more holes of the at least one hole of the cable rack, the cable strip loops round at least a part of the cable, and the first end of the cable strip is connected to the second end of the cable strip.

2. The cable fixation system according to claim 1, wherein the cable rack comprises a plurality of holes, and wherein to fix or clamp the cable: the cable strip passes through two holes of the plurality of holes of the cable rack.

3. The cable fixation system according to claim 1, wherein the cable strip has a mechanical strength of at least 1 kN.

4. The cable fixation system according to claim 1, wherein the cable strip comprises thermoset, thermoplastic, or a rubber material.

5. The cable fixation system according to claim 1, wherein the cable strip comprises a metallic material.

6. The cable fixation system according to claim 1, wherein the cable strip comprises a plurality of layers, and wherein at least two of the layers comprise different materials.

7. The cable fixation system according to claim 1, wherein the cable strip comprises a layer of one material with particles of a second material.

8. The cable fixation system according to claim 1, wherein the cable strip is UV resistant and/or is flame retardant.

9. A low voltage, medium voltage or high voltage cable fixation system, comprising:
a cable strip; and
a cable rack;
wherein the cable rack is configured to be mounted to a cable compartment of a low voltage, medium voltage, or high voltage switchgear;
wherein the cable rack comprises a plurality of holes;
wherein a first end of the cable strip is configured to connect to the cable rack via a hole of the plurality of holes of the cable rack;
wherein a second end of the cable strip is configured to connect to the cable rack via a hole of the plurality of holes of the cable rack;
wherein the cable strip is configured to fix or clamp a cable of the low voltage, medium voltage, or high voltage switchgear, and wherein to fix or clamp the cable: the first end of the cable strip is connected to the cable rack via a first hole of the plurality of holes of the cable rack, the second end of the cable strip is connected to the cable rack via a second hole of the plurality of holes of the cable rack, and the cable strip loops round at least a part of the cable.

10. The cable fixation system according to claim 9, wherein the first end of the cable strip is connected to the cable rack via a bolt or screw through the first hole of the plurality of holes of the cable rack and wherein the second end of the cable strip is connected to the cable rack via a bolt or screw through the second hole of the plurality of holes of the cable rack.

11. The cable fixation system according to claim 9, wherein the first end of the cable strip is connected to the cable rack via a bolt or screw through the first hole of the plurality of holes of the cable rack and wherein the second end of the cable strip is connected to the cable rack via the bolt or screw through the first hole of the plurality of holes of the cable rack.

12. The cable fixation system according to claim 10, wherein the first hole of the plurality of holes of the cable rack is threaded, and wherein the second hole of the plurality of holes of the cable rack is threaded.

13. The cable fixation system according to claim 10, wherein the first end of the cable strip is connected to the cable rack via the bolt through the first hole of the plurality of holes of the cable rack from one side and a nut from the other side and wherein the second end of the cable strip is connected to the cable rack via the bolt or screw through the second hole of the plurality of holes of the cable rack from one side and a nut from the other side.

14. The cable fixation system according to claim 10, wherein the first end of the cable strip is connected to the cable rack via the bolt through the first hole of the plurality of holes of the cable rack from one side and a nut from the other side and wherein the second end of the cable strip is connected to the cable rack via the bolt or screw through the first hole of the plurality of holes of the cable rack from one side and the nut from the other side.

15. The cable fixation system according to claim 9, wherein the cable strip has a mechanical strength of at least 1 kN.

16. The cable fixation system according to claim 9, wherein the cable strip comprises thermoset, thermoplastic, or a rubber material.

17. The cable fixation system according to claim 9, wherein the cable strip comprises a metallic material.
